(19) United States
(12) Patent Application Publication
(10) Pub. No.: US 2022/0243107 A1
(43) Pub. Date: Aug. 4, 2022

(54) HEAT TRANSFER COMPOSITION AND HEAT EXCHANGE SYSTEM

(71) Applicant: Gree Electric Appliances, Inc. of Zhuhai, Zhuhai (CN)

(72) Inventors: Youlin ZHANG, Zhuhai (CN); Yancui YU, Zhuhai (CN); Huan ZHAO, Zhuhai (CN); Peiyu LEI, Zhuhai (CN); Youxuan LIANG, Zhuhai (CN); Yujie HUANG, Zhuhai (CN)

(21) Appl. No.: 17/613,839

(22) PCT Filed: Jun. 18, 2020
(86) PCT No.: PCT/CN2020/096848

§ 371 Date: Nov. 23, 2021

(30) Foreign Application Priority Data
Sep. 12, 2019 (CN) 201910863809.X

(51) Int. Cl. C09K 5/04; F25B 1/04

(52) U.S. Cl. CPC C09K 5/045; F25B 1/04; C09K 2205/122; C09K 2205/40; C09K 2205/22; C09K 2205/32; C09K 2205/126

(57) ABSTRACT

Provided is a heat transfer composition, which is characterized in that the heat transfer composition comprises the following three components: 1,1,1,2-tetrafluoroethane (R134a) with a mass ratio of 28%-46%, 2,3,3,3-tetrafluoropropene (R1234yf) with a mass ratio of 33%-71%, and trans 1,3,3,3-tetrafluoropropene (R1234ze(E)) with a mass ratio of I %-23%. The described heat transfer composition which replaces R134a not only has the environmentally friendly features of having low GWP and zero ODP, but also has excellent thermal performance. When applied in a centrifugal chiller, the volumetric refrigeration capacity and energy efficiency are equivalent to those of a centrifugal unit using an R134a refrigerant, and the slip in temperature is small; thus, the present application may become a heat transfer composition to replace R134a.

### TECHNICAL FIELD

The present disclosure relates to a refrigeration cryogenic technology, specifically to a heat transfer composition and a heat exchange system.

### BACKGROUND

R134a (1,1,1,2-tetrafluoroethane) is hydrofluorocarbon, which is different from chlorofluorocarbons or hydrochlorofluorocarbons. It does not have significant ozone depletion potential (ODP). Since 1990s, R134a has been used as alternative refrigerant gas for the chlorofluorocarbon or hydrochlorofluorocarbon which has significant ODP and is regulated by the Montreal Protocol.

As the most widely used low and medium-temperature environmentally friendly refrigerants, R134a is a very effective and safe alternative to R-12 due to its good comprehensive performance. It is mainly used in most areas where an R12 refrigerant is used, including: refrigerators, freezers, water dispensers, automobile air conditioners, central air conditioners, dehumidifiers, refrigeration houses, commercial refrigeration, water chillers, ice cream machines, refrigeration condensing units and other refrigeration equipment, and can also be used in aerosol propellants, medical aerosols, insecticide sprays, poly(plastic)physical foaming agents, magnesium alloy shielding gas, and other industries.

However, the problem of global warming is becoming more and more serious. Although R134a has a little destroy effect on the ozone layer, its GWP value is 1300, so R134a is a controlled HFCs refrigerant listed in the Kigali Amendment and will soon be eliminated in the future (It has been limited in the European regulations and its availability and use in air-conditioning or refrigeration equipment will be gradually limited). Therefore, it is urgent to find a refrigerant with outstanding environmentally friendly performance that not only meets an environmental protection requirement but also meets an energy efficiency requirement of an air-conditioning system and an R134a replacement refrigerant with good comprehensive performance.

### SUMMARY

In view of this, the present disclosure provides a heat transfer composition with higher environmental friendliness and better thermal performance. It has a GWP less than or equal to 600, has obvious environmental protection advantages, and has good thermal performance applicable to a heat transfer system such as a refrigeration system of an air conditioner. The problem of low refrigeration capacity of a current existing refrigerant that replaces R134a can be solved.

In order to achieve the above purpose, the present disclosure adopts the technical solution: a heat transfer composition. The heat transfer composition includes three components: 1,1,1,2-tetrafluoroethane (R134a) with a mass ratio of 28%-46%, 2,3,3,3-tetrafluoropropene (R1234yf) with a mass ratio of 33%-71%, and trans-1,3,3,3-tetrafluoropropene (R1234ze(E)) with a mass ratio of 1%-23%. The mass ratio is based on the total mass of all the components of the heat transfer composition. The heat transfer composition has a global warming potential (GWP) not greater than 600.

Further optionally, the mass ratios of the three components included in the heat transfer composition are respectively as follows: 36%-46% of 1,1,1,2-tetrafluoroethane (R134a), 33%-63% of 2,3,3,3-tetrafluoropropene (R1234yf), and 1%-22% of trans-1,3,3,3-tetrafluoropropene (R1234ze(E)). The mass ratios of the three components included in the heat transfer composition are respectively within the above ranges, and the heat transfer composition has higher capacity and energy efficiency performance.

Further optionally, wherein the heat transfer composition includes the three components at least with a mass ratio of 97%. The percentage is based on the total mass of the three components in the heat transfer composition. A lubricant and/or stabilizer and other components with a mass ratio of 3% can be further added, so as to improve the heat transfer efficiency of the transfer composition.

Further optionally, the heat transfer composition includes the three components at least with a mass ratio of 99.5%. The percentage is based on the total mass of the three components in the heat transfer composition. An additional lubricant with a mass ratio of 0.5% can be further added, so as to improve the heat transfer efficiency of the transfer composition.

Further optionally, the heat transfer composition is composed of the three components.

Further optionally, the heat transfer composition is composed of three components: 1,1,1,2-tetrafluoroethane (R134a) with a mass ratio of 40%-46%, 2,3,3,3-tetrafluoropropene (R1234yf) with a mass ratio of 33%-59%, and trans-1,3,3,3-tetrafluoropropene (R1234ze(E)) with a mass ratio of 1%-21%. The mass ratios of the three components of the heat transfer composition are within the above-mentioned ranges, respectively, so the heat transfer composition has higher capacity and energy efficiency performance.

Further optionally, the heat transfer composition is composed of three components: 1,1,1,2-tetrafluoroethane (R134a) with a mass ratio of 46%, 2,3,3,3-tetrafluoropropene (R1234yf) with a mass ratio of 48%, and trans-1,3,3,3-tetrafluoropropene (R1234ze(E)) with a mass ratio of 6%. By considering the flammability, the GWP, and the energy efficiency, the three-component heat transfer composition is better.

Further optionally, the slip in temperature of the heat transfer composition is less than 0.5° C.

The present disclosure further provides a method for replacing an existing heat exchange fluid contained in a heat exchange system, including: removing at least a part of the existing heat exchange fluid from the system, the existing heat exchange fluid being R134a; and by means of introducing a heat transfer composition into the system to replace at least a part of the existing heat exchange fluid, forming any one of the above heat transfer composition, the refrigeration capacity being ensured to be 90% to 110% of the refrigeration capacity of the R134a refrigerant.

The present disclosure further provides a heat exchange system including a compressor, a condenser, an evaporator and an expansion device which are fluidly connected, and a heat transfer composition that realizes fluid connection. The heat transfer composition is any one of the above heat transfer compositions.

Further optionally, the heat exchange system is an HVACR system.

Further optionally, the heat exchange system is a centrifugal chiller; the compressor is an oil-free centrifugal compressor; and the condenser and the evaporator are shell-and-tube heat exchanger. The condenser may be a shell-and-tube heat exchanger, or a finned-tube heat exchanger.

Further optionally, the heat transfer composition is used for the HVACR system.

Further optionally, the heat transfer composition is used for any one of air-conditioning systems of motor vehicles, household, commercial and industrial air-conditioning equipment, household, commercial and industrial refrigerators, refrigeration houses, freezers, refrigeration conveyors, ice machines, and dehumidifiers.

All the components in the present disclosure can be commercially available, or prepared by existing methods in the art. The ratios of all the components in the present disclosure are obtained after massive screenings, which is the condition to ensure the excellent performance of the heat transfer composition.

The present disclosure has the beneficial effects.

(1) The 1,1,1,2-tetrafluoroethane (R134a) introduced in the present disclosure is a non-flammable refrigerant, and the flammability of the 2,3,3,3-tetrafluoropropene (R1234yf) and the flammability of the trans 1,3,3,3-tetrafluoropropene (R1234ze(E)) can be reduced by means of changes of the components, thereby obtaining a heat transfer composition having good safety performance, a GWP less than or equal to 600, and zero ODP.

(2) Compared with the R134a refrigerant, the heat transfer composition of the present disclosure has comparative relative volumetric refrigeration capacity and relative COP, and can replace the R134a refrigerant.

(3) Besides the volumetric refrigeration capacity and energy efficiency, the selection of constituents and components of the heat transfer composition of the present disclosure also considers slip in temperature. A combination with a large boiling point difference between constituents may form a non-azeotropic mixture with a large phase change temperature difference (a slip in temperature), and the slip in temperature of the mixed working medium of the present disclosure is less than 0.52° C.

### BRIEF DESCRIPTION OF THE DRAWINGS

The above-mentioned and other objectives, features and advantages of the present disclosure will become more apparent by describing example embodiments in detail with reference to the accompanying drawings. The drawings in the following description are only some embodiments of the present disclosure. Those of ordinary skill in the art can further obtain other drawings according to these drawings without creative work.

FIG. 1 is a diagram of a unipolar compression cycle system of a centrifugal chiller in one embodiment of the present disclosure.

In the drawings:
1: compressor; 2: condenser; 3: evaporator; 40: throttling device.

### DETAILED DESCRIPTION OF THE EMBODIMENTS

The promising heat transfer fluids on the market must satisfy certain very special physical, chemical, and economic properties, and, in some cases, must be an extremely strict combination that satisfies the physical, chemical, and economic properties. Moreover, there are many different types of heat transfer systems and heat transfer equipment. In many cases, it is important that the heat transfer fluid used in such systems should have a special combination that satisfy various properties required by individual systems. For example, a system based on a vapor compression cycle usually involves the phase change of a refrigerant, that is, at a relatively low pressure, the refrigerant is transformed from liquid to a vapor phase by heat absorption, and the vapor is compressed at a relatively elevated pressure. The heat is removed at the relatively elevated pressure and temperature, and the vapor is condensed into a liquid phase. Then, this cycle is restarted at reduced pressure.

As one of the most widely used low and medium-temperature environmentally friendly refrigerants, R134a is a very effective and safe alternative to R-12 due to its good comprehensive performance. It is used in most areas where an R12 refrigerant is used.

However, with the global warming, some new measures have emerged (for example, the Kigali Amendment to the Montreal Protocol, the Paris Agreement, and the Significant New Alternatives Policy, “SNAP”)) to phase out refrigerants with high global warming potential (GWP), such as some HFC refrigerants.

The low and medium-temperature environmentally-friendly refrigerant R134a (1,1,1,2-tetrafluoroethane) with the GWP of 1300 has good comprehensive performance (which is non-flammable, explosive, non-toxic, non-irritating, and non-corrosive), but it is still proposed to be replaced.

HFO (such as R1234yf, R1234ze(E)) is proposed as an alternative to the R134a (its GWP is 1300).

Basic parameters of the three constituent substances are listed in Table 1.

TABLE 1
Basic parameters of constituent substances in the heat transfer component

| | | | Molecular | Standard | Critical | Critical | | |
|---|---|---|---|---|---|---|---|---|
| | | | weight, | boiling | temperature, | pressure, | | |
| Member | Name | Chemical | g/mol | point, ° C. | ° C. | MPa | ODP | GWP |
| R134a | 1,1,1,2-tetrafluoroethane | CH₂FCF₃ | 102.03 | −26.07 | 101.06 | 4.059 | 0 | 1300 |
| R1234yf | 2,3,3,3-tetrafluoropropene | CF₃CF═CH₂ | 114.04 | −29.49 | 94.7 | 3.382 | 0 | 1 |
| R1234ze(E) | trans-1,3,3,3-tetrafluoropropene | CHF═CHCF₃ | 114.04 | −18.97 | 109.36 | 3.635 | 0 | 1 |

Since there is no chlorine atom in the molecule, the ODP of the R1234yf is 0. Since the R1234yf has a lifespan of only 11 days in the atmosphere, the GWP is 1, and atmospheric decomposition products are the same as those of the R134a. The impact of the R1234yf on the climate environment can be almost negligible, which is much lower than that of the R134a. Safe R1234yf has no flash point and is weakly flammable. The flammability of the R1234yf is far lower than that of several currently known flammable refrigerants. The R1234yf is a low-toxic chemical substance and belongs to level A of ASHRAE toxicity. However, the disadvantage is that it has lower refrigeration capacity and lower thermodynamic efficiency compared to the R134a.

The GWP of the R1234ze(E) is 1, which is much less than that of the R134a, but it is flammable (classified as A2L according to the ASHRAE standard 34) and has lower refrigeration capacity than the R134a.

However, it is surprised to find that although some significant physical and chemical properties of the R1234yf and the R1234ze(E) are known. Either R1234yf or R1234ze(E), when only these single refrigerants are used as the heat transfer compositions in a large-sized refrigeration air-conditioning system, particularly such as a centrifugal chiller, it is very hard to ensure the heat exchange capacity and the energy efficiency ratio of an original heat exchange system taking R134a as a refrigerant. Particularly, if it is desired that the GWP shall not be greater than 600, it is very hard to satisfy the heat exchange capacity and the energy efficiency ratio without other adaptive adjustment.

In some HVACR implementation solutions designed for the R134a, people often expect a refrigerant composition or an improved composition to be similar to the R134a, so that there is no need to adjust the HVACR system or the HVACR system is adjusted a little. For example, the refrigeration capacity of the R134a refrigerant can be ensured to be 90% to 110%. However, as it is known, the performance of a refrigerant is based on the properties of a refrigerant composition. If the properties of the refrigerants are different, parameters such as the refrigeration capacity, the slip in temperature, the coefficient of performance, the discharge temperature of the compressor, the mass flow rate, and the density of the refrigerant in a fluid phase may be different. If it cannot ensure that the HVACR system is adjusted to use a working fluid with refrigeration capacity greater than 110% or less than 90%, this may result in requiring a pressure that exceeds a design limit, a larger number of refrigerants, and/or a relatively large temperature difference that reduces the efficiency of the HVACR system.

Based on the comprehensive consideration of the heat transfer capacity, the energy efficiency ratio and the GWP value of the above heat transfer composition, it is surprised to find that if the 1,1,1,2-tetrafluoroethane (R134a), the 2,3,3,3-tetrafluoropropene (R1234yf), and the trans-1,3,3,3-tetrafluoropropene (R1234ze(E)) are combined together, the advantages of these substances will be integrated more favorably to maximize their strengths and avoid their weaknesses. Thereby the GWP value is not greater than 600 and further the comprehensive performance such as the refrigeration capacity is 90% to 110% of the refrigeration capacity of the R134a refrigerant in high heat transfer capacity, and high energy efficiency ratio (such as COP equal to 0.96). Especially when the 1,1,1,2-tetrafluoroethane (R134a) with the mass ratio of 28%-46%, the 2,3,3,3-tetrafluoropropene (R1234yf) with the mass ratio of 33%-71%, and the trans-1,3,3,3-tetrafluoropropene (R1234ze(E)) with the mass ratio of 1%-23% are used, this advantage is even more prominent.

The main purpose of the present disclosure is to provide a heat transfer composition which can be used as a substitute or alternative to the R134a, and/or other substitutes or alternatives that contains fluorohydrocarbons (HFC), hydrogen fluoride olefin (HFO), and hydrogen fluoride ether (HFE) to the R134a. Compared to the R134a, especially in terms of the GWP, the heat transfer composition has improved environmental impact characteristics and higher thermal characteristics, is particularly suitable for use in, for example, air conditioners of motor vehicles and household, commercial and industrial air-conditioning and refrigeration applications, and has the thermodynamic characteristics of replacement refrigerant gas with improved characteristics.

A preparation method of the heat transfer composition of the present disclosure is to physically mix 1,1,1,2-tetrafluoroethane (R134a), 2,3,3,3-tetrafluoropropene (R1234yf), trans 1,3,3,3-tetrafluoropropene (R1234ze(E)) and other refrigerant components in a liquid phase state at a temperature of 23° C.-27° C. and a pressure of 0.1 MPa according to their corresponding mass ratios. The 1,1,1,2-tetrafluoroethane is a non-flammable component. By adding the non-flammable components in their mass ratios, the flammability of other components can be reduced, so as to meet the requirements of safety and energy efficiency ratio.

Multiple specific embodiments are provided below. The proportions of the components are all mass percentages, and the sum of the mass percentages of the component substances of each kind of heat transfer composition is 100%.

Embodiment 1, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 28:49:23, uniformly, to obtain a heat transfer composition.

Embodiment 2, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 46:33:21, uniformly, to obtain a heat transfer composition.

Embodiment 3, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 30:69:1, uniformly, to obtain a heat transfer composition.

Embodiment 4, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 32:62:6, uniformly, to obtain a heat transfer composition.

Embodiment 5, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 34:51:15, uniformly, to obtain a heat transfer composition.

Embodiment 6, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 36:53:11, uniformly, to obtain a heat transfer composition.

Embodiment 7, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 38:54:8, uniformly, to obtain a heat transfer composition.

Embodiment 8, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 40:55:5, uniformly, to obtain a heat transfer composition.

Embodiment 9, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 46:48:6, uniformly, to obtain a heat transfer composition.

Embodiment 10, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 30:48:22, uniformly, to obtain a heat transfer composition.

Embodiment 11, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 28:71:1, uniformly, to obtain a heat transfer composition.

Embodiment 12, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 30:63:7, uniformly, to obtain a heat transfer composition.

Embodiment 13, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 33:59:8, uniformly, to obtain a heat transfer composition.

Comparative example 1, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 25:64:11, uniformly, to obtain a heat transfer composition.

Comparative example 2, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 50:47:3, uniformly, to obtain a heat transfer composition.

Comparative example 3, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 46:31:23, uniformly, to obtain a heat transfer composition.

Comparative example 4, three components: 1,1,1,2-tetrafluoroethane (R134a), 2,3,3,3-tetrafluoropropene (R1234yf), and trans 1,3,3,3-tetrafluoropropene (R1234ze(E)) are physically mixed in a liquid phase at a temperature of 23° C.-27° C. and a pressure of 0.1 MPa according to mass ratios of 38:37:25, uniformly, to obtain a heat transfer composition.

Comparative example 5, two components: 1,1,1,2-tetrafluoroethane (R134a) and 2,3,3,3-tetrafluoropropene (R1234yf) are physically mixed in a liquid phase at a temperature of 23° C.-27° C. and a pressure of 0.1 MPa according to mass ratios of 46:54, uniformly, to obtain a heat transfer composition.

Comparative example 6, two components: 1,1,1,2-tetrafluoroethane (R134a) and 1,3,3,3-tetrafluoropropene (R1234ze(E)) are physically mixed in a liquid phase at a temperature of 23° C.-27° C. and a pressure of 0.1 MPa according to mass ratios of 46:54, uniformly, to obtain a heat transfer composition.

Comparative example 7, two components: 2,3,3,3-tetrafluoropropene (R1234yf) and 1,3,3,3-tetrafluoropropene (R1234ze(E)) are physically mixed in a liquid phase at a temperature of 23° C.-27° C. and a pressure of 0.1 MPa according to mass ratios of 46:54, uniformly, to obtain a heat transfer composition.

In Table 2, basic parameters such as molecular weights, standard boiling points, and environmental performance of the above-mentioned embodiments and R134a are compared.

TABLE 2
Basic parameters of the heat transfer composition

| | Molecular | Standard | Critical | Critical | |
|---|---|---|---|---|---|
| | weight | boiling | tempera- | pressure | |
| Refrigerant | g/mol | point, ° C. | ture, ° C. | MPa | GWP |
| R134a | 102.03 | −25.7 | 101.1 | 4.06 | 1300 |
| Embodiment 1 | 110.40 | −28.24 | 97.69 | 3.659 | 364.72 |
| Embodiment 2 | 108.18 | −27.79 | 98.60 | 3.773 | 598.54 |
| Embodiment 3 | 110.15 | −29.77 | 94.54 | 3.568 | 390.7 |
| Embodiment 4 | 109.9 | −29.41 | 95.4 | 3.613 | 416.68 |
| Embodiment 5 | 109.65 | −28.72 | 96.84 | 3.669 | 442.66 |
| Embodiment 6 | 109.41 | −28.98 | 96.34 | 3.664 | 468.64 |
| Embodiment 7 | 109.16 | −29.15 | 95.98 | 3.662 | 494.62 |
| Embodiment 8 | 108.91 | −29.32 | 95.59 | 3.658 | 520.6 |
| Embodiment 9 | 108.18 | −29.08 | 96.12 | 3.703 | 598.54 |
| Embodiment 10 | 110.15 | −28.27 | 97.66 | 3.669 | 390.7 |
| Embodiment 11 | 110.4 | −29.78 | 94.5 | 3.556 | 364.72 |
| Embodiment 12 | 110.15 | −29.38 | 95.48 | 3.606 | 390.7 |
| Embodiment 13 | 109.78 | −29.26 | 95.74 | 3.630 | 429.67 |
| Comparative | 110.78 | −29.17 | 95.89 | 3.593 | 325.75 |
| example 1 | | | | | |
| Comparative | 107.70 | −29.17 | 95.87 | 3.711 | 650.5 |
| example 2 | | | | | |
| Comparative | 108.18 | −27.60 | 98.92 | 3.780 | 598.54 |
| example 3 | | | | | |
| Comparative | 109.16 | −27.75 | 98.63 | 3.734 | 494.62 |
| example 4 | | | | | |
| Comparative | 108.18 | −29.52 | 95.04 | 3.662 | 598.54 |
| example 5 | | | | | |
| Comparative | 108.18 | −23.63 | 104.12 | 3.839 | 598.54 |
| example 6 | | | | | |
| Comparative | 114.04 | −25.93 | 100.40 | 3.511 | 1 |
| example 7 | | | | | |

It can be known in Table 2 that the GWP of the three-component heat transfer composition provided by the present disclosure is less than or equal to 600, and the ODP is 0, so the heat transfer composition has an obvious advantage in environmental protection, and its GWP is much less than that of the R134a. In addition, the molecular weight of the three-component heat transfer composition is slightly greater than that of the R134a, and the critical point is lower than that of the R134a. Meanwhile, it can be seen in combination with the data in the embodiments and the comparative examples that when the contents of the formula components in the present disclosure are changed or a mixed working medium is prepared, the components cannot well achieve a synergistic effect, which will increase the GWP and/or slip in temperature and/or flammability of the mixed working medium and affect the heat exchange effect and the environmental friendliness of the unit during use. Meanwhile, reducing the number of kinds of the components in the formula will also increase the GWP and/or slip in temperature and/or flammability. The content of the R134a in Comparative example 1 is less than the mass ratio of the present disclosure. Although the GWP of the composition is lower, the flammability is enhanced. The content of the R134a in Comparative example 2 is greater than the mass ratio of the present disclosure, and the GWP of the composition is relatively high. The composition in Comparative example 6 does not contain R134a, so it is flammable and less safe.

In Table 3, thermal parameters (i.e., a compression ratio and a discharge temperature) and relative thermal performances (i.e., relative refrigeration capacities per unit and relative efficiency COP) of the heat transfer composition in the above embodiments and the R134a under refrigeration conditions (i.e., an evaporation temperature is 6° C., a condensation temperature is 36° C., a degree of superheat is 5° C., and a degree of supercooling is 5° C.) are compared.

TABLE 3
Performance comparison results between the
heat transfer composition and the R134a

| | | | | Relative | |
|---|---|---|---|---|---|
| | | | | volumetric | |
| | Slip in | Discharge | Com- | refrig- | Rela- |
| | tempera- | tempera- | pression | eration | tive |
| Refrigerant | ture, ° C. | ture, ° C. | ratio | capacity | COP |
| R134a | 0 | 56.82 | 2.852 | 1 | 1 |
| Embodiment 1 | 0.49 | 52.22 | 2.830 | 0.957 | 0.9601 |
| Embodiment 2 | 0.5 | 53.52 | 2.846 | 0.968 | 0.9676 |
| Embodiment 3 | 0.05 | 51.04 | 2.733 | 1.014 | 0.9776 |
| Embodiment 4 | 0.11 | 51.43 | 2.752 | 1.005 | 0.9757 |
| Embodiment 5 | 0.32 | 52.13 | 2.795 | 0.983 | 0.9694 |
| Embodiment 6 | 0.23 | 52.02 | 2.778 | 0.996 | 0.9736 |
| Embodiment 7 | 0.17 | 51.97 | 2.766 | 1.005 | 0.9768 |
| Embodiment 8 | 0.11 | 51.94 | 2.755 | 1.014 | 0.9799 |
| Embodiment 9 | 0.16 | 52.46 | 2.767 | 1.014 | 0.9811 |
| Embodiment | 0.47 | 52.31 | 2.827 | 0.961 | 0.9617 |
| 10 | | | | | |
| Embodiment | 0.05 | 50.92 | 2.733 | 1.011 | 0.9764 |
| 11 | | | | | |
| Embodiment | 0.13 | 51.35 | 2.755 | 1.001 | 0.9740 |
| 12 | | | | | |
| Embodiment | 0.15 | 51.61 | 2.762 | 1.001 | 0.9747 |
| 13 | | | | | |
| Comparative | 0.2 | 51.24 | 2.769 | 0.986 | 0.9689 |
| example 1 | | | | | |
| Comparative | 0.11 | 52.58 | 2.76 | 1.024 | 0.9848 |
| example 2 | | | | | |
| Comparative | 0.55 | 53.67 | 2.857 | 0.961 | 0.9658 |
| example 3 | | | | | |
| Comparative | 0.58 | 53.16 | 2.855 | 0.954 | 0.9614 |
| example 4 | | | | | |
| Comparative | 0.02 | 52.08 | 2.741 | 1.031 | 0.986 |
| example 5 | | | | | |
| Comparative | 0.61 | 55.71 | 3.019 | 0.856 | 0.949 |
| example 6 | | | | | |
| Comparative | 0.99 | 52.22 | 2.973 | 0.844 | 0.924 |
| example 7 | | | | | |

(*Note:
The slip in temperature is a difference between a dew point temperature and a bubble point temperature under a working pressure, and the maximum value is used)

It can be seen from Table 3 that the volumetric refrigeration capacity of refrigerants in some formulas is greater than the volumetric refrigeration capacity of the R134a, and a slip in temperature is less than 0.2° C. These refrigerants are azeotropic refrigerants. The volumetric refrigeration capacity of refrigerants in other formulas is less than the volumetric refrigeration capacity of the R134a, but its relative volumetric refrigeration capacity is not less than 0.95, and a slip in temperature is less than 0.6° C. These refrigerants are near-azeotropic refrigerants. The energy efficiency COP in all the formulas is less than the energy efficiency COP of the R134a, but it is greater than 0.95. It can be seen from the comparative examples that the reduction of the components of the heat transfer composition of the present disclosure will affect the performance of the composition, such as enhancing the flammability, increasing the slip in temperature, reducing its relative volumetric refrigeration capacity, increasing the compression ratio, etc. Compared with other embodiments, the comprehensive performance of the refrigerants in Embodiments 6 to 9 in terms of the slip in temperature, the relative volumetric refrigeration capacity, the COP, and the like.

It should be noted that the R1234yf or the R1234ze(E) can exist as different isomers or stereoisomers. Unless otherwise stated, the implementation solutions disclosed herein include all single isomers, single stereoisomers, or any combination or mixture thereof. For example, the R1234ze(E) includes only an E (trans) isomer of the R1234ze, and does not include a Z (cis) isomer.

Therefore, the heat transfer composition provided by the present disclosure to replace the R134a not only has the environmental protection characteristics of low GWP and zero ODP, but also has excellent thermal performance. Under the same refrigeration conditions, the volumetric refrigeration capacity and the energy efficiency COP of a refrigeration device using the heat transfer composition are equivalent to using the R134a refrigerant. The slip in temperature is small. The heat transfer composition can become an environmentally friendly refrigerant to replace the R134a. Meanwhile, the heat transfer composition provided in the present disclosure to replace the R134a can be alternatively added with lubricants, stabilizers, highly polar solvents, and other additives according to the needs of a refrigeration system, so as to improve the performance of the heat transfer composition and the stability of the refrigeration system.

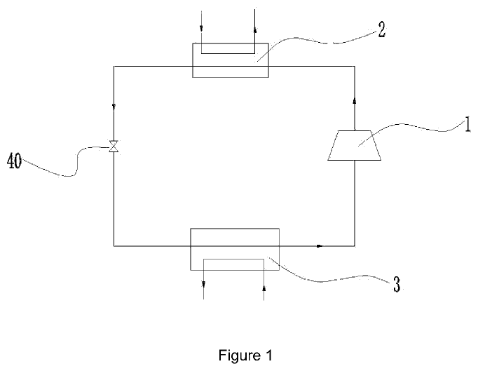

FIG. 1 below is a schematic diagram of a refrigeration loop of a fluidly connected HVACR system according to one of the above implementation solutions of the heat transfer composition.

The refrigeration loop includes a compressor 1, a condenser 2, a throttling device 40, and an evaporator 3. It can be understood that parts of the refrigeration loop are fluidly connected by the heat transfer composition. The refrigeration loop can be configured as a cooling system that can operate in a cooling mode (for example, a fluid cooler of HVACR, an air-conditioning system, etc.), and/or the refrigeration loop can be configured to operate as a heat pump system that can operate in a cooling mode and a heating mode. The refrigeration loop applies the known principles of air compression and cooling. The refrigeration loop can be configured to heat or cool process fluid (such as water and air). The refrigeration loop can include additional parts, such as an intermediate heat exchanger, one or more flow control devices, a four-way valve, a dryer, a liquid suction heat exchanger, and even a waste heat absorption heat exchanger for a power battery, according to the application.

The present embodiment is a centrifugal chiller. The compressor 1 is a centrifugal compressor. The evaporator 3 and the condenser 2 are of a shell-tube type. The working fluid uses the heat transfer composition described in the embodiments of the present disclosure.

As shown in FIG. 1, during the operation of the refrigerant loop in the present embodiment, the working fluid (such as a refrigerant and a refrigerant mixture) flows from the evaporator 3 into the compressor 1 in a gaseous state at a relatively low pressure. The compressor 1 compresses the air into a high-pressure state, which also heats the air. After the compression, the air with the relatively high pressure and relatively high temperature flows from the compressor 1 to the condenser 2. In addition to the refrigerant flowing through the condenser 2, external fluid (such as external air, external water, and cooling water) also flows through the condenser 2. When there is external fluid flowing through the condenser 2, the external fluid absorbs the heat from the working fluid. The working fluid is condensed into liquid, and then flows into the throttling device 40. The throttle device 40 reduces the pressure of the working fluid. The reduced pressure causes the working fluid to expand and transform into a mixed air-liquid state. Then, the air/liquid working fluid with relatively low temperature flows into the evaporator 3. The process fluid (such as air and water) also flows through the evaporator 3. According to the known principles, the working fluid absorbs the heat from the process fluid as it flows through the evaporator 3. When the working fluid absorbs the heat, the working fluid is evaporated into vapor. The working fluid then returns to the compressor 1. When the refrigeration loop operates in the cooling mode, for example, the above process is continued.

The refrigerant compositions and methods herein can be used in the refrigeration loop of the HVACR system. For example, a method for improving the refrigerant composition can be applied to a thermal loop. In addition, the refrigerant composition herein can be used as a working fluid in the thermal loop, and can be used in any one of air-conditioning systems of motor vehicles, household, commercial and industrial air-conditioning equipment, household, commercial and industrial refrigerators, refrigeration houses, freezers, refrigeration conveyors, ice machines, and dehumidifiers.

It can be understood that in the present embodiment, single-stage compression can also be changed to multi-stage compression. The specific multi-stage compression principle will be omitted here.

The exemplary embodiments of the present disclosure have been specifically shown and described above. It should be understood that the present disclosure is not limited to the detailed structure, arrangement or implementation method described herein. Rather, the present disclosure intends to cover various modifications and equivalent arrangements within the spirit and scope of the appended claims.

What is claimed is:

1. A heat transfer composition, the heat transfer composition comprises three components: 1,1,1,2-tetrafluoroethane with a mass ratio of 28%-46%, 2,3,3,3-tetrafluoropropene with a mass ratio of 33%-71%, and trans-1,3,3,3-tetrafluoropropene with a mass ratio of 1%-23%, wherein the mass ratio is based on the total mass of all the components of the heat transfer composition; and the heat transfer composition has a global warming potential not greater than 600.

2. The heat transfer composition according to claim 1, wherein the mass ratios of the three components comprised in the heat transfer composition are respectively as follows: 36%-46% of 1,1,1,2-tetrafluoroethane, 33%-63% of 2,3,3,3-tetrafluoropropene, and 1%-22% of trans-1,3,3,3-tetrafluoropropene.

3. The heat transfer composition according to claim 1, wherein the heat transfer composition comprises the three components at least with a mass ratio of 97%, wherein the percentage is based on the total mass of the three components in the heat transfer composition.

4. The heat transfer composition according to claim 3, wherein the heat transfer composition comprises the three components at least with a mass ratio of 99.5%, wherein the percentage is based on the total mass of the three components in the heat transfer composition.

5. The heat transfer composition according to claim 4, wherein the heat transfer composition is composed of the three components.

6. The heat transfer composition according to claim 5, wherein the heat transfer composition is composed of three components: 1,1,1,2-tetrafluoroethane with a mass ratio of 28%-46%, 2,3,3,3-tetrafluoropropene with a mass ratio of 33%-71%, and trans-1,3,3,3-tetrafluoropropene with a mass ratio of 1%-23%.

7. The heat transfer composition according to claim 6, wherein the heat transfer composition is composed of three components: 1,1,1,2-tetrafluoroethane with a mass ratio of 46%, 2,3,3,3-tetrafluoropropene with a mass ratio of 48%, and trans-1,3,3,3-tetrafluoropropene with a mass ratio of 6%.

8. The heat transfer composition according to claim 1, wherein a slip in temperature of the heat transfer composition is less than 0.5° C.

9. A method for replacing an existing heat exchange fluid contained in a heat exchange system, comprising: removing at least a part of the existing heat exchange fluid from the system, the existing heat exchange fluid being R134a; and by means of introducing a heat transfer composition into the heat exchange system to replace at least a part of the existing heat exchange fluid, forming the above heat transfer composition according to claim 1, the refrigeration capacity being ensured to be 90% to 110% of the refrigeration capacity of the R134a refrigerant.

10. A heat exchange system comprising a compressor, a condenser, an evaporator, an expansion device, which are fluidly connected, and a heat transfer composition that realizes fluid connection, wherein the heat transfer composition is the heat transfer composition according to claim 1.

11. The heat exchange system according to claim 10, wherein the heat exchange system is an HVACR system.

12. The heat exchange system according to claim 11, wherein the heat exchange system is a centrifugal chiller; the compressor is an oil-free centrifugal compressor; and the condenser and the evaporator are shell-and-tube heat exchanger.

13. Use of the heat transfer composition according to claim 1, wherein the heat transfer composition is used in an HVACR system, air-conditioning systems of motor vehicles, household, commercial and industrial air-conditioning equipment, household, commercial and industrial refrigerators, refrigeration houses, freezers, refrigeration conveyors, ice machines, or dehumidifiers.

14. (canceled)

15. The heat transfer composition according to claim 2, wherein the heat transfer composition comprises the three components at least with a mass ratio of 97%, wherein the percentage is based on the total mass of the three components in the heat transfer composition.

16. The heat transfer composition according to claim 15, wherein the heat transfer composition comprises the three components at least with a mass ratio of 99.5%, wherein the percentage is based on the total mass of the three components in the heat transfer composition.

17. The method for replacing an existing heat exchange fluid contained in a heat exchange system according to claim 9, wherein the mass ratios of the three components comprised in the heat transfer composition are respectively as follows: 36%-46% of 1,1,1,2-tetrafluoroethane, 33%-63% of 2,3,3,3-tetrafluoropropene, and 1%-22% of trans-1,3,3,3-tetrafluoropropene.

18. The method for replacing an existing heat exchange fluid contained in a heat exchange system according to claim 9, wherein the heat transfer composition is composed of the three components.

19. The method for replacing an existing heat exchange fluid contained in a heat exchange system according to claim 18, wherein the heat transfer composition is composed of three components: 1,1,1,2-tetrafluoroethane with a mass ratio of 28%-46%, 2,3,3,3-tetrafluoropropene with a mass ratio of 33%-71%, and trans-1,3,3,3-tetrafluoropropene with a mass ratio of 1%-23%.

20. The method for replacing an existing heat exchange fluid contained in a heat exchange system according to claim 19, wherein the heat transfer composition is composed of three components: 1,1,1,2-tetrafluoroethane with a mass ratio of 46%, 2,3,3,3-tetrafluoropropene with a mass ratio of 48%, and trans-1,3,3,3-tetrafluoropropene with a mass ratio of 6%.
